(19) United States
(12) Patent Application Publication
(10) Pub. No.: US 2022/0207328 A1
(43) Pub. Date: Jun. 30, 2022

(54) CONTROL DEVICE

(71) Applicant: RKC INSTRUMENT INC., Tokyo (JP)

(72) Inventors: Katsutoshi IZAKI, Tokyo (JP); Seiji HASHIMOTO, Kiryu-city (JP)

(21) Appl. No.: 17/606,141

(22) PCT Filed: Apr. 26, 2019
(86) PCT No.: PCT/JP2019/017878

§ 371 Date: Oct. 25, 2021

(51) Int. Cl. G06N 3/04; G06N 3/08

(52) U.S. Cl. CPC G06N 3/0445; G06N 3/08

(57) ABSTRACT

To provide a control device that causes a neural network to perform learning without any effects of dead time even for a dead-time system and that has the capability of improving transient characteristics for a command input. A control device includes a feedback controller configured to control a control target including a dead-time component, a reference model unit including a dead-time component and configured to output a desired response waveform for an input. A learning based controller is configured to perform learning in a manner that a change in an output from the learning based controller minimizes an error between an output of the control target and an output of the reference model unit or causes the error to be a predetermined threshold or smaller, the output from the learning based controller being added to an output of the feedback controller and input to the control target.

### TECHNICAL FIELD

The present invention relates to a control device and particularly relates to a control device for controlling a control target including dead time.

### BACKGROUND ART

As a technique using a neural network for feedback control, feedback error learning method and system are known that use an inverse system of a control target. FIG. 2 illustrates a block diagram of the feedback error learning system. In this technique, a neural network controller 110 uses, as a supervisory signal, an output xc of a feedback controller to perform learning such that xc is caused to be 0 as learning proceeds. In this way, learning and control are performed to cause an error e to be 0 and an output y to be a desired value yd. Hence, after the learning, a controller to be used is shifted from a feedback controller 120 to the neural network controller 110. This consequently changes a structure of a control system 100 from a feedback structure to a feedforward structure.

As techniques in which a reference model is employed in a control system using a neural network, the following techniques are disclosed, for example. PTL 1 discloses a control device configured to input, to a neural network unit, an output of a reference model and an output of a feedback control unit, the reference model being configured to output a time series data signal of an ideal expected response, based on a steering amount signal. PTL 2 discloses a structure in which a feedback controller itself is configured as a neural network learning based controller. PTL 3 discloses a control device in which an estimation device is configured by a neural network having the nonlinear function approximation capability and is incorporated as a compensator component.

### CITATION LIST

### Patent Literature

[PTL 1] JP 07-277286 A

[PTL 2] JP 06-035510 A

[PTL 3] JP 04-264602 A

### SUMMARY OF INVENTION

### Technical Problem

A system as that illustrated in FIG. 2 described above may not improve responsiveness in an output response waveform for a step command provided repeatedly, at each step, in other words, with time. This is considered to be due to dead time of a control target and that a neural network fails to appropriately perform learning in some cases in a state where, even if an input signal is provided to the control target, no response to the input signal (no output from the control target) is provided.

In view of this, a conceivable technique to prevent delay in learning by a neural network caused by delay in response with an output due to dead time is a technique of using a reference model that is capable of providing a desired response and including dead time in the reference model, to cause the neural network to perform learning such that an actual output follows an output of the reference model. However, techniques using a reference model as those in PTL 1 to PTL 3, for example, have the following problems.

First, the technique disclosed in PTL 1 is basically similar to feedback error learning of a known type and delay for a control target further increases even when dead time is provided in the reference model. Hence, the technique disclosed in PTL 1 makes no improvement in delay in learning.

The technique disclosed in PTL 2 may prevent delay in learning by including dead time in the reference model. However, a model of a control target is required at an initial stage of designing a neural network controller. This causes the controller to have a complex design and may also cause a model error. In addition, the neural network controller needs to compensate for all the compensation targets such as a response for a desired value, disturbance, and variation. It is hence difficult to design and adjust the controller for each compensation target, which complicates modification based on learning by a compensator. The technique disclosed in PTL 3 also has similar problems as those of PTL 2.

All the techniques described above are control methods mainly focusing on followability to a reference model in a system where no dead time is included or where effects of dead time can be ignored, and do not focus on improvement of performance for improvement in transient characteristics in consideration of dead time. For this reason, it is difficult for the techniques described above to achieve both transient response characteristics for a dead-time system and further improvement in characteristics by effects of neural network learning.

In view of above, an object of the present invention is to construct a control system capable of solving at least one of the above-described problems. The present invention also has an object to provide a control device that causes a neural network to perform learning without any effects of dead time even for a dead-time system and that has the capability of improving transient characteristics for a command input.

### Solution to Problem

According to a first aspect of the present invention, there is provided a control device including:

a feedback controller configured to control a control target including a dead-time component;

a reference model unit including a dead-time component and configured to output a desired response waveform for an input; and

a learning based controller configured to perform learning in a manner that a change in an output from the learning based controller minimizes an error between an output of the control target and an output of the reference model unit or causes the error to be a predetermined threshold or smaller, the output from the learning based controller being added to an output of the feedback controller and input to the control target.

According to a second aspect of the present invention, there is provided a control device to be applied to a control system for controlling a control target by using a predesigned feedback controller, the control device including:

a reference model unit including a dead-time component and configured to output a desired response waveform for an input; and

a learning based controller configured to perform learning in a manner that a change in an output from the learning based controller minimizes an error between an output of the control target and an output of the reference model unit or causes the error to be a predetermined threshold or smaller, the output from the learning based controller being added to an output of the feedback controller and input to the control target.

### Advantageous Effects of Invention

According to the present invention, it is possible to provide a control device that causes a neural network to perform learning without any effects of dead time even for a dead-time system and that has the capability of improving transient characteristics for a command input.

### BRIEF DESCRIPTION OF DRAWINGS

FIG. 1 is a block diagram of a control system according to the present embodiment.

FIG. 2 is a block diagram of a control system of a comparative example.

FIG. 3 illustrates a repetitive step response waveform in the control system of the comparative example.

FIG. 4 provides comparative diagrams in each of which repetitive step response waveforms in the control system of the comparative example are superposed.

FIG. 5 illustrates a repetitive step response waveform in the control system of the present embodiment.

FIG. 6 provides comparative diagrams in each of which repetitive step response waveforms in the control system of the present embodiment are superposed.

### DESCRIPTION OF EMBODIMENTS

An embodiment of the present invention will be described below with reference to the drawings.

### <Overview of the Present Embodiment>

First, an overview of the present embodiment will be described. A control system of the present embodiment employs a control technique for causing, through learning, an output of a control target including dead time, such as a process control system, to follow an output of a reference model similarly including dead time.

A known feedback (FB) controller can be used for a feedback (FB) controller. A response of the control target is caused to follow an output of the reference model including the dead time. To enable this, in a neural network controller, a neural network is caused to perform learning by using, as a supervisory signal for the neural network, an error between an output of the control target (actual output) and an output of the reference model, to minimize the error, for example. An output of the neural network controller is added to an output of the feedback controller and the addition result is input to the control target, to control the control target.

### <Description of the Present Embodiment>

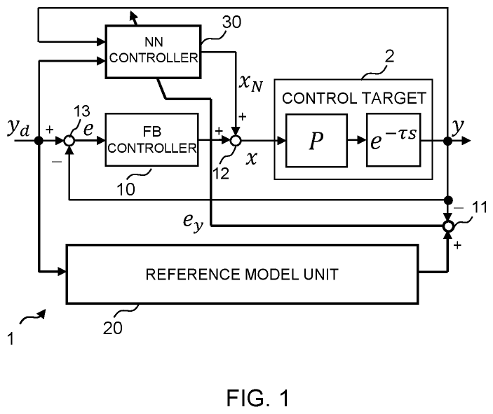

FIG. 1 is a block diagram of the control system according to the present embodiment. The control system according to the present embodiment includes a control device 1 that controls a control target 2. The control device 1 includes a feedback controller 10, a reference model unit 20, and a neural network controller 30.

The feedback controller 10 controls the control target 2 in accordance with a predetermined desired value yd for an output of the control target 2. For example, the feedback controller 10 inputs an error e between the predetermined desired value (set value, also referred to as SV) yd and an output (process value, also referred to as a measured value and PV) of the control target 2, to perform prescribed control computation, and outputs an operation amount (manipulated value, first operation amount) for the control target 2. The feedback controller 10 operates as a main controller, for example. The feedback controller 10 is, for example, a controller for causing an output of the control target 2 to operate according to a desired design in a case that no modeling error and no disturbance are assumed. As the feedback controller 10, for example, a PID controller that can be designed automatically by auto-tuning or the like can be used. It is also possible to use an I-PD controller with suppressed overshoot for the feedback controller 10 and improve rising with respect to the desired value by the neural network controller 30.

The reference model unit 20 includes dead time (dead-time component) and outputs a desired response waveform for an input. The reference model unit 20 inputs the desired value yd. The relationship between an input and an output of the reference model unit 20 can be expressed, for example, by using a first-order delay system including a dead-time component, but is not limited thereto. The relationship may be any appropriate relationship including a dead-time component. The dead time for the reference model unit 20 can be set to be the same as the dead time of the control target 2, for example. The dead time for the reference model unit 20 may be substantially the same as the dead time for the control target 2. Here, “substantially the same” may refer, for example, to a degree at which responsiveness of an output of the control target 2 is improved by the neural network controller 30. The “substantially the same” may refer to a value obtained by rounding the dead time of the control target 2 at a predetermined digit, in other words, a value within a range of a predetermined tolerance. As examples, the dead time for the reference model unit 20 may be within a range of approximately plus or minus 10% of the dead time of the control target 2 or a range of approximately plus or minus 30% of the dead time of the control target 2. An error ey between the output of the reference model unit 20 including the dead time and the output of the control target 2 is provided to the neural network controller 30 as a supervisory signal.

An output of the neural network controller 30 (second operation amount) is added to the output of the feedback controller 10 (first operation amount) and the addition result is input to the control target 2. The neural network controller 30 performs learning by using a neural network in a manner that a change (adjustment) in the output of the neural network controller 30 minimizes the error ey between the output of the control target 2 and the output of the reference model unit 20 or causes the error ey to be a predetermined threshold or smaller. For example, the neural network controller 30 performs learning to minimize a square error ey², by the steepest descent method and back propagation. The neural network controller 30 inputs the desired value yd and an output y of the control target as input signals. The neural network controller 30 provides an output corresponding to the input signals and a learning result. An output xN from the neural network controller 30 is added to the output of the feedback controller 10 to obtain an operation amount x as described above and the operation amount is input to the control target 2. In this way, adding the output xN of the neural network controller 30 to the output of the feedback controller 10 and inputting the addition result to the control target 2 enable separation of roles between the feedback controller 10 and the neural network controller 30. Note that the neural network controller 30 may further input the error ey as an input signal.

Note that the neural network includes inputs and outputs, and one or a plurality of intermediate layers. Each of the intermediate layers is composed of a plurality of nodes. Any appropriate structure can be used for the structure of the neural network, and a known learning method can be used as the learning method of the neural network.

The control device 1 may include a differentiator 11 configured to obtain the error ey between the output y of the control target 2 and the output of the reference model unit 20, an adder 12 configured to add the output of the feedback controller 10 and the output of the neural network controller 30 together, and a differentiator 13 configured to obtain an error e between the desired value yd and the output y of the control target 2.

The reference model unit 20 and the neural network controller 30 may be implemented by a digital device including a processing unit, such as a central processing unit (CPU) and a digital signal processor (DSP), and a storage unit, such as a memory, for example. For the processing unit and the storage unit of the reference model unit 20 and the neural network controller 30, a shared processing unit and a shared storage unit may be used, or separate processing units and separate storage units may be used. The neural network controller 30 may include a plurality of processing units and perform at least some processes in parallel.

### (Effects)

According to the control device of the present embodiment, the following effects are exerted, for example. Note that the control device of the present embodiment is not necessarily limited to a device that exerts all the following effects.

As the feedback controller 10, a controller that can be designed by using auto-tuning can be used. This eliminates the need for a model of the control target 2 in designing the feedback controller 10. The need of a model of the control target 2 is also eliminated in the designing of the neural network controller 30. Hence, no model is needed for the designing of the controllers of the control device 1.

In the control system of the present embodiment, learning is performed such that the output of the control target 2 follows the output of the reference model unit 20. The dead time included in the reference model unit 20 enables to prevent the neural network controller 30 from starting learning using the neural network in a state with no output of the control target 2 (that is, causality is established). Moreover, the problem in neural network learning that learning is performed ahead of dead time can be avoided. Hence, it is not necessary to delay neural network learning by the dead time, which also eliminates the need of setting a long learning cycle intentionally. This can prevent a phenomenon in which the neural network controller 30 provides an excessive control input in order to increase an output of the control target 2.

A role of the feedback controller 10 is mainly to operate so as to satisfy the nominal specification of the design stage. For example, the feedback controller 10 operates so as to satisfy a specification as a control device (controller) in the control system, a PID operation specification, and the like. In contrast, a role of the neural network controller 30 is to operate so as to cause an output of the control target 2 to follow an output of the reference model unit 20 after the learning. Moreover, in a case that a modeling error and disturbance occur, the neural network controller 30 compensates for the modeling error and the disturbance. In such a case that the error and/or disturbance occur, an error consequently occurs between an output of the control target 2 and an output of the reference model unit 20, and the neural network controller 30 operates based on this error to compensate for the modeling error and disturbance.

In addition to the effects above, the control device of the present embodiment also exerts the following effects.
With the configuration of following an output of the reference model unit 20, a control input is less likely to be excessive, even when learning by the neural network proceeds based on the setting and adjustment of the reference model unit 20. In other words, an input of the control target 2 can be indirectly adjusted.
A model of a control target is not required in designing the neural network controller 30. Moreover, since the feedback controller 10 designed through auto-tuning can be used, the control system can be designed in a model-less manner.
Even when learning by the neural network proceeds, a feedback control system can be maintained without being shifted to a feedforward structure. For example, in a case that the error between an output of the reference model unit 20 and an output of the control target 2 is zero, this state is equivalent to that in which only the feedback controller 10 is in operation.
By employing an I-PD structure for the feedback controller 10, only responsiveness can be improved without any overshoot as learning by the neural network proceeds. For example, control that enables the following is possible: even though the rising of an output of the control target 2 is delayed immediately after control starts, the rising is improved as the learning proceeds, with overshoot being suppressed. In a case that learning of the neural network controller 30 is not satisfactory or a case that the performance in control is not improved, or the like, initial basic performance is guaranteed by the feedback controller 10 even with an output of the neural network controller 30 being restricted or being zero output.
Since learning is performed based on an output of the reference model unit 20, application to a multiple-input and multiple-output system (application for MIMO) is facilitated. For example, it is possible to perform control of making temperatures uniform at multipoints (multiple outputs) including a transient state, in a control system for controlling temperatures at multipoints. Note that, in a case of application to a multiple-input and multiple-output system, the error, operation amount, and the like described above include a plurality of elements corresponding to inputs and outputs, and can be expressed in vectors, for example.

The control device of the present embodiment is applicable to control systems including dead time, for example, a process control system and a temperature adjustment system. Concrete examples include temperature control and air conditioning systems, an injection molding apparatus, a hot plate, and the like. In such a field, it is common to design a feedback controller through auto-tuning using on/off of a control input, without deriving a model of a control target. The present embodiment has an advantage that, by additionally introducing a controller using a neural network into such an existing control system, it is possible to maintain the use of an existing design method using no model and further to enable improvement in control performance through operation and learning.

### (Simulation Results)

Simulation results and effects of a control system using the control device 1 of the present embodiment will be described in comparison with a comparative example.

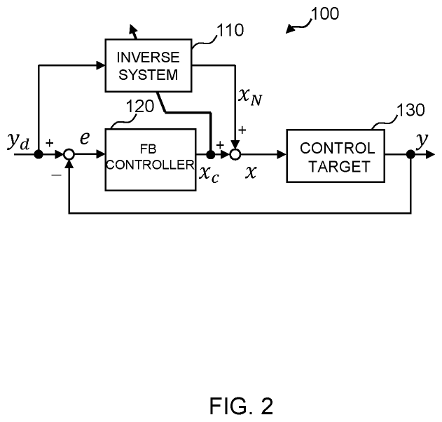

First, response waveforms in the comparative example will be described. FIG. 2 is a block diagram of a control system of the comparative example. As the comparative example, the feedback error learning system described above as the related art is used. In this example, a neural network controller 110 uses, as a supervisory signal, an output xc of a feedback controller 120 to perform learning such that xc is caused to be 0 as the learning proceeds. In this way, the control system of the comparative example performs learning and control such that an error e between a desired value yd and a control target 130 is caused to be 0 (in other words, an output y is caused to be the desired value yd). Hence, after the learning, a controller to be used is shifted from the feedback controller 120 to the neural network controller 110. Here, a PI controller is used as the feedback controller 120. It is assumed that a neural network of the neural network controller 110 includes two intermediate layers, and that the number of nodes in each of the layers is 10.

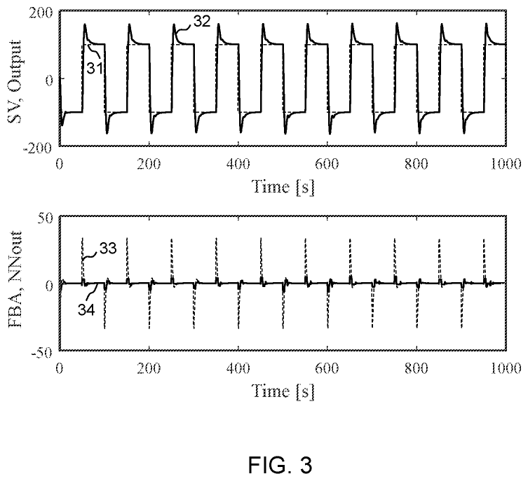

FIG. 3 illustrates a repetitive step response waveform in the control system of the comparative example. The horizontal axis in FIG. 3 represents time. FIG. 3 illustrates, in an upper half, an output response waveform 32 of the control target 130 with respect to a desired value (repetitive step commands) 31, and illustrates, in a lower half, outputs (FBA) 33 of the feedback controller 120 and outputs (NNout) 34 of the neural network controller 110. As illustrated in FIG. 3, there is no improvement in responsiveness with time.

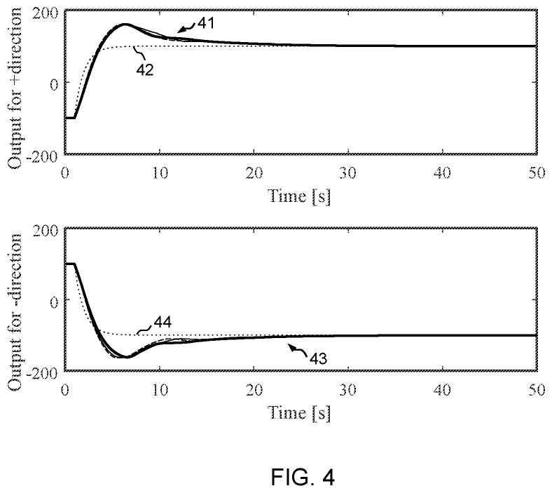

FIG. 4 provides comparative diagrams in each of which repetitive step response waveforms in the control system of the comparative example are superposed. The horizontal axis in FIG. 4 represents time. FIG. 4 illustrates, in an upper half, waveforms 41 illustrating responses (step responses) to a plurality of positive-direction step commands in a superposed manner, and illustrates, in a lower half, waveforms 43 illustrating responses (step responses) to a plurality of negative-direction step commands in a superposed manner. More specifically, each of both the upper half and the lower half of FIG. 4 illustrates, in a superposed manner, step response waveforms for the first, fifth, and tenth step commands (the respective step waveforms being illustrated by a thin line, a broken line, and a thick line) of the repetitive step commands 31 as those illustrated in FIG. 3, by considering timing of the rising or falling of each of the step commands as time 0. In addition, as reference examples, ideal response waveforms 42 and 44 are illustrated by dotted lines. As seen in FIG. 4, the response waveforms are almost superposed, and no sign of improvement in responsiveness at each step is found.

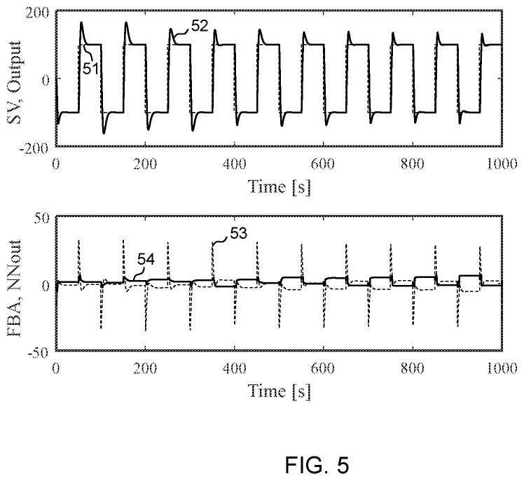

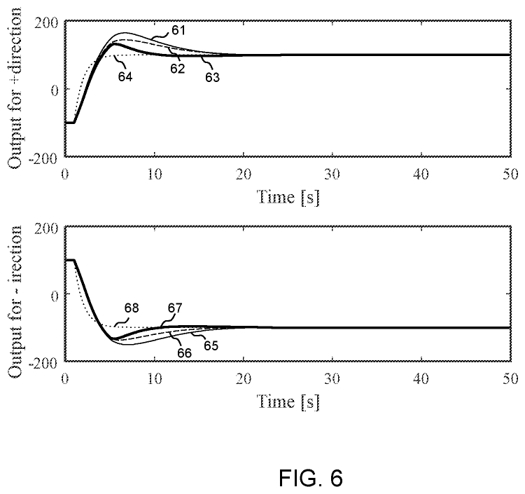

In contrast, as an example, simulation results of the control system of the present embodiment are illustrated in FIGS. 5 and 6. FIG. 5 illustrates a repetitive step response waveform in the control system of the present embodiment. FIG. 6 provides comparative diagrams in each of which repetitive step response waveforms in the control system of the present embodiment are superposed.

It is assumed that the configurations of the control target 2 and the feedback controller 10 are the same as those of the control target 130 and the feedback controller 120 of the comparative example illustrated in FIG. 2. It is also assumed that the neural network of the neural network controller 30 has the same configuration as that of the neural network controller 110, specifically, the neural network includes two intermediate layers and the number of nodes is 10.

The horizontal axis in FIG. 5 represents time. FIG. 5, as FIG. 3, illustrates, in an upper half, an output response waveform 52 of the control target 2 with respect to the desired value (repetitive step commands) 51, and illustrates, in a lower half, outputs (FBA) 53 of the feedback controller 10 and outputs (NNout) 54 of the neural network controller 30.

The horizontal axis in FIG. 6 represents time. FIG. 6, as FIG. 4, illustrates, in an upper half, waveforms 61 to 63 illustrating responses (step responses) to a plurality of positive-direction step commands in a superposed manner, and illustrates, in a lower half, waveforms 65 to 67 illustrating responses (step responses) to a plurality of negative-direction step commands in a superposed manner. More specifically, each of both the upper half and the lower half of FIG. 6 illustrates, in a superposed manner, the step response waveforms 61 and 65 for the first step command, the step response waveforms 62 and 66 for the fifth step command, and the step response waveforms 63 and 67 for the tenth step command, of the repetitive step commands 51 as those illustrated in FIG. 5, by considering timing of the rising of each of the step commands as time 0. In addition, as reference examples, ideal response waveforms (for example, outputs of the reference model unit 20) 64 and 68 are illustrated by dotted lines.

It can be confirmed that, as a result of repetition of a step response, overshoot with respect to the desired value is reduced, and the settling time is also shortened, for positive-direction and negative-direction responses, to consequently follow the output of the reference model. From the lower part of FIG. 5, it can be confirmed that, as a result of repetition of a step response, the output (NNout) 54 of the neural network controller 30 increases. This indicates that learning by the neural network controller 30 is performed such that the output signal y follows the reference model output.

### (Others)

In the above-described embodiment, the neural network controller 30 performs learning by using a neural network but may perform learning by using a function other than a neural network. In other words, the neural network controller 30 may be a learning based controller. A second control device having a configuration obtained by eliminating the feedback controller 10 from the control device 1 can be provided. For example, the above-described control system may be configured by applying a control device including the reference model unit 20 and the neural network controller 30 to a control system for controlling a control target by using a known predesigned feedback controller.

The configurations and processing described above can be implemented by a computer including a processing unit and a storage unit. The processing unit performs the processing of each of the configurations. The storage unit stores a program to be executed by the processing unit. The above-described processing can be implemented as a control method performed by the processing unit. The above-described processing can be implemented by a program or a program medium including instructions for the processing unit to perform the above-described processing, a computer-readable recording medium or a non-transitory recording medium storing therein the program, or the like.

### INDUSTRIAL APPLICABILITY

The control device and the control system of the present embodiment are applicable to a control system that controls a control target including dead time, for example. As examples, the control device and the control system of the present embodiment are applicable to a process control system and a temperature adjustment system. More concrete examples include temperature control and air conditioning systems, an injection molding apparatus, a hot plate, and the like.

### REFERENCE SIGNS LIST

1 Control device
2 Control target
10 Feedback controller
20 Reference model unit
30 Neural network controller
51 Desired value (repetitive step command)
52 Output response waveform
53 Output of feedback controller (FBA)
54 Output of neural network controller (NNout)

What is claimed is:

1. A control device comprising:
a feedback controller configured to control a control target including a dead-time component;
a reference model unit including a dead-time component and configured to output a desired response waveform for an input; and
a learning based controller configured to perform learning in a manner that a change in an output from the learning based controller minimizes an error between an output of the control target and an output of the reference model unit or causes the error to be a predetermined threshold or smaller, the output from the learning based controller being added to an output of the feedback controller and input to the control target.

2. The control device according to claim 1, wherein the learning based controller is a neural network controller configured to perform learning by using a neural network.

3. The control device according to claim 2, wherein the neural network controller uses, as a supervisory signal for the neural network, the error between the output of the control target and the output of the reference model unit to perform learning by using the neural network to minimize the error or cause the error to be the predetermined threshold or smaller.

4. The control device according to claim 1, wherein dead time for the reference model unit is set to be same or substantially same as dead time for the control target.

5. A control device to be applied to a control system for controlling a control target by using a predesigned feedback controller, the control device comprising:
a reference model unit including a dead-time component and configured to output a desired response waveform for an input; and
a learning based controller configured to perform learning in a manner that a change in an output from the learning based controller minimizes an error between an output of the control target and an output of the reference model unit or causes the error to be a predetermined threshold or smaller, the output from the learning based controller being added to an output of the feedback controller and input to the control target.
